(19) United States
(12) Patent Application Publication
(10) Pub. No.: US 2010/0257763 A1
(43) Pub. Date: Oct. 14, 2010

(54) Frame device for a license plate

(76) Inventor: Ming-Liang Hu, Tainan Hsien (TW)

Correspondence Address: HOLLAND & HART, LLP, P.O BOX 8749, DENVER, CO, 80201, US

(21) Appl. No.: 12/798,703

(22) Filed: Apr. 9, 2010

(30) Foreign Application Priority Data
Apr. 13, 2009 (TW) 098206014

(51) Int. Cl. B60R 13/10

(52) U.S. Cl. 40/209

(57) ABSTRACT

A frame device for mounting a license plate on a vehicle body includes a frame member and a plurality of screw fasteners. The frame member includes a frame body in a form of a loop, and upper and lower fastener tabs. The frame body has upper and lower frame edge portions. Each upper fastener tab is formed with a fastener hole and is extended rearwardly then downwardly from the upper frame edge portion to form a downward gap for extension of an upper part of the license plate therein. Each lower fastener tab is formed with a fastener hole and is extended rearwardly then upwardly from the lower frame edge portion to form an upward gap for extension of a lower part of the license plate therein. Each screw fastener is extended through the fastener hole in a respective fastener tab for securing the frame member onto the vehicle body.

### CROSS-REFERENCE TO RELATED APPLICATION

This application claims priority of Taiwanese Application No. 098206014, filed on Apr. 13, 2009.

### BACKGROUND OF THE INVENTION

1. Field of the Invention

The present invention relates to a frame device and, more particularly, to a frame device for mounting a license plate on a vehicle body.

2. Description of the Related Art

A conventional frame device is available for mounting a license plate on a vehicle body. A plurality of screw fasteners are sequentially extended through holes in the license plate and the frame device to temporarily position the former to the latter. The screw fasteners are then used to fasten the assembly of the license plate and the frame device on the vehicle body. However, the screw fasteners, which have yet to be tightened, are likely to fall off from the assembly during the process of mounting the assembly on the vehicle body, so that the screw fasteners need to be repositioned once again. Therefore, it is not convenient to mount the license plate on the vehicle body using the conventional frame device.

### SUMMARY OF THE INVENTION

Therefore, the object of the present invention is to provide a frame device that can facilitate mounting of a license plate on a vehicle body.

Accordingly, a frame device of the present invention is adapted for mounting a license plate on a vehicle body. The frame device comprises a frame member and a plurality of screw fasteners. The frame member includes a frame body in a form of a loop, a set of upper fastener tabs, and a set of lower fastener tabs. The frame body has an upper frame edge portion and a lower frame edge portion vertically spaced apart from each other. Each upper fastener tab is formed with a fastener hole and is extended rearwardly then downwardly from the upper frame edge portion to form a downward gap with a rear side of the upper frame edge portion for extension of an upper part of the license plate therein. Each lower fastener tab is formed with a fastener hole and is extended rearwardly then upwardly from the lower frame edge portion to form an upward gap with a rear side of the lower frame edge portion for extension of a lower part of the license plate therein. Each of the screw fasteners is extended through the fastener hole in a respective one of the upper and lower fastener tabs for securing the frame member onto the vehicle body.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded rear perspective view of a first preferred embodiment of a frame device according to the present invention;

FIG. 2 is a schematic side view of the first preferred embodiment when used to mount a license plate on a vehicle body;

FIG. 3 is a front view of an assembly of a license plate and a frame member of the first preferred embodiment; and

FIG. 4 is a schematic side view of a second preferred embodiment of the frame device when used to mount the license plate on the vehicle body.

### DETAILED DESCRIPTION OF THE PREFERRED EMBODIMENTS

Before the present invention is described in greater detail, it should be noted that like components are assigned the same reference numerals throughout the following disclosure.

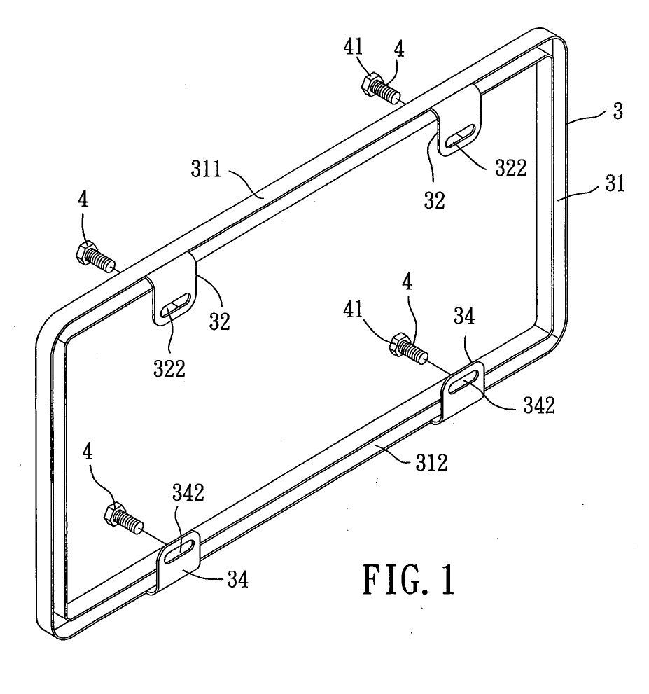

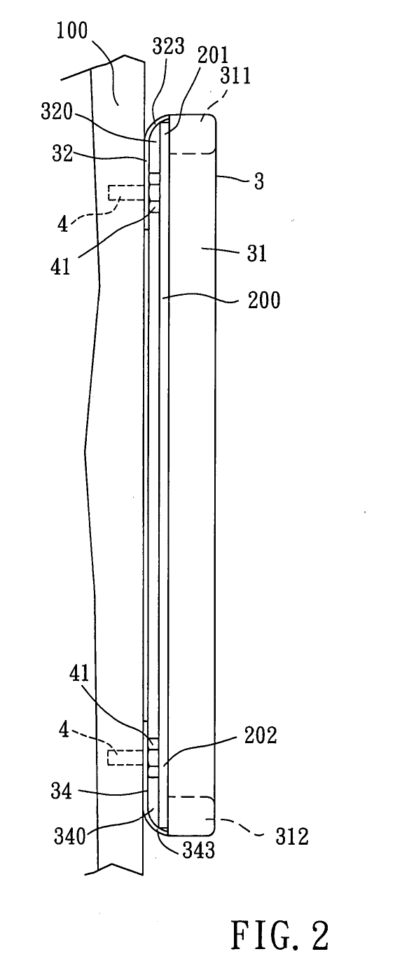

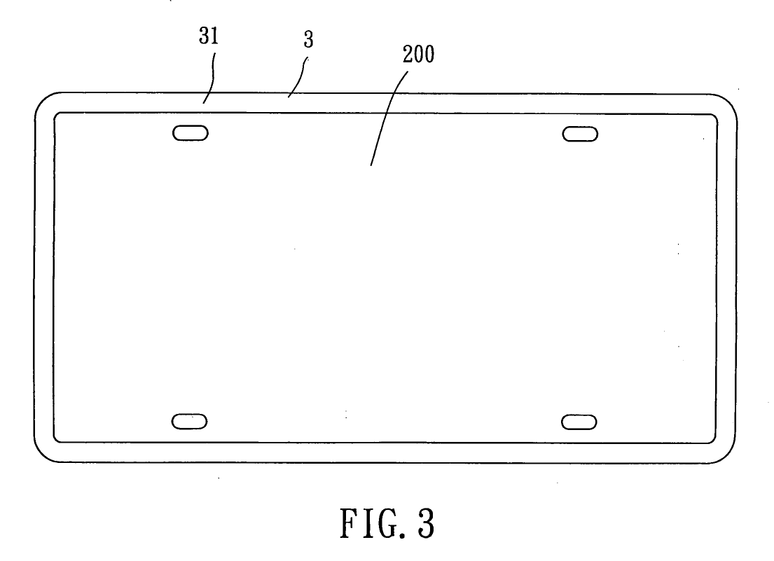

Referring to FIGS. 1 to 3, a first preferred embodiment of a frame device of the present invention is adapted for mounting a license plate 200 on a vehicle body 100. The frame device comprises a frame member 3 and a plurality of screw fasteners 4.

The frame member 3 includes a frame body 31 in a form of a loop, a set of upper fastener tabs 32, and a set of lower fastener tabs 34. The frame body 31 has an upper frame edge portion 311 and a lower frame edge portion 312 vertically spaced apart from each other. Each upper fastener tab 32 is formed with a fastener hole 322 and is extended rearwardly then downwardly from the upper frame edge portion 311 to form a downward gap 320 with a rear side of the upper frame edge portion 311 for extension of an upper part 201 of the license plate 200 therein. Each lower fastener tab 34 is formed with a fastener hole 342 and is extended rearwardly then upwardly from the lower frame edge portion 312 to form an upward gap 340 with a rear side of the lower frame edge portion 312 for extension of a lower part 202 of the license plate 200 therein. In this embodiment, each of the upper and lower fastener tabs 32, 34 has a root portion 323, 343, and a vertical distance between the root portions 323, 343 of the upper and lower fastener tabs 32, 34 is approximately equal to the height of the license plate 200. Accordingly, the root portions 323, 343 of the upper and lower fastener tabs 32, 34 are configured to abut against the top and bottom edges of the upper and lower parts 201, 202 of the license plate 200, respectively. In addition, each of the fastener holes 322, 342 is a horizontally extending elongate hole in this embodiment.

The frame body 31 is in the shape of a rectangular loop in this embodiment. However, the shape of the frame body 31 is not limited thereto.

Each of the screw fasteners 4 is extended through the fastener hole 322, 342 in a respective one of the upper and lower fastener tabs 32, 34 for securing the fastener tabs 32, 34 onto the vehicle body 100. Furthermore, each screw fastener 4 has a head part 41 that is disposed at a front side of the respective one of the upper and lower fastener tabs 32, 34, and that is for pressing the license plate 200 against a corresponding one of the upper and lower frame edge portions 311, 312.

When the frame device is used to mount the license plate 200 on the vehicle body 100, the screw fasteners 4 are first extended through the fastener holes 322, 342 in the fastener tabs 32, 34 of the frame member 3, respectively, for securing the fastener tabs 32, 34 onto the vehicle body 100. Thereafter, the license plate 200 can be inserted from either one of the right side or the left side of the frame member 3 into the gaps 320, 340 between the fastener tabs 32, 34 and the frame body 31. In this embodiment, the fastener tabs 32, 34 are configured to abut against the top and bottom edges of the upper and lower parts 201, 202 of the license plate 200, and the license plate 200 mounted on the frame body 3 covers the fastener holes 322, 342 and the screw fasteners 4 such that the head parts 41 of the screw fasteners 4 can cooperate with the upper and lower frame portions 311, 312 to clamp the upper and lower parts 201, 202 of the license plate 200. In other embodiments, it is not necessary to configure the fastener tabs 32, 34 for abutting against the top and bottom edges of the upper and lower parts 201, 202 of the license plate 200, so long as the screw fasteners 4 can cooperate with the the frame body 31 to clamp the license plate 200.

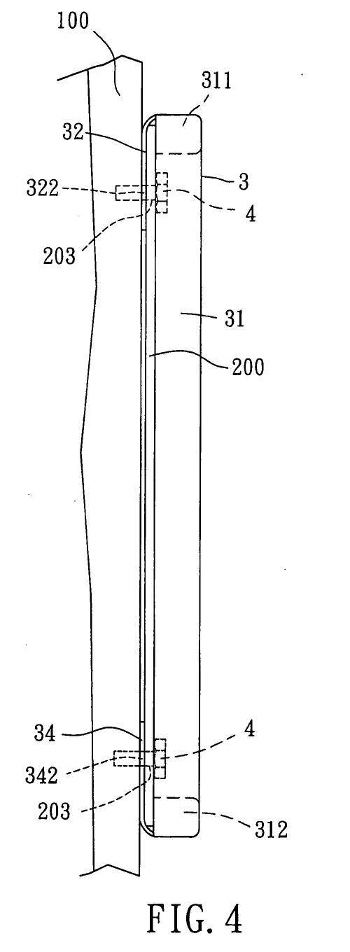

FIG. 4 illustrates the second preferred embodiment of the frame device according to the present invention. The second preferred embodiment differs from the first preferred embodiment in the following aspects.

In the present embodiment, the license plate 200 is provided with a plurality of mounting holes 203. The fastener hole 322, 342 in each of the fastener tabs 32, 34 is disposed to be aligned with a respective one of the mounting holes 203. In addition, the spacing between each of the fastener tabs 32, 34 and the corresponding one of the frame edge portions 311, 312 of the frame body 31 is slightly less than the thickness of the license plate 200 such that the fastener tabs 32, 34 are not only configured to abut against the top and bottom edges of the upper and lower parts 201, 202 of the license plate 200 but also cooperate with the frame edge portions 311, 312 to clamp the upper and lower parts 201, 202 of the license plate 200. Accordingly, it is not necessary to secure the frame member 3 on the vehicle body 100 in advance using the screw fasteners 4. That is, the license plate 200 is first secured to the frame member 3 before the assembly of the license plate 200 and the frame member 3 is mounted on the vehicle body 100 by extending each of the screw fasteners 4 through one of the mounting holes 203 in the license plate 200 and the fastener hole 322, 342 in the respective one of the fastener tabs 32, 34.

In sum, by virtue of the fastener tabs 32, 34 on the rear side of the frame body 31, mounting of the license plate 200 on the vehicle body 100 can be facilitated. In particular, in the first preferred embodiment of this invention, the license plate 200 can be secured to the frame member 3 after mounting the latter on the vehicle body 100 using the screw fasteners 4, whereas in the second preferred embodiment of this invention, the license plate 200 can be secured to the frame member 3 before mounting the latter on the vehicle body 100 using the screw fasteners 4. Furthermore, since the license plate 200 can cover the screw fasteners 4 in the first preferred embodiment of this invention, the appearance of the frame member 3 is not affected adversely by the screw fasteners 4.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A frame device adapted for mounting a license plate on a vehicle body, said frame device comprising:
a frame member including
a frame body in a form of a loop, said frame body having an upper frame edge portion and a lower frame edge portion vertically spaced apart from each other,
a set of upper fastener tabs, each being formed with a fastener hole and being extended rearwardly then downwardly from said upper frame edge portion to form a downward gap with a rear side of said upper frame edge portion for extension of an upper part of the license plate therein, and
a set of lower fastener tabs, each being formed with a fastener hole and being extended rearwardly then upwardly from said lower frame edge portion to form an upward gap with a rear side of said lower frame edge portion for extension of a lower part of the license plate therein; and
a plurality of screw fasteners, each being extended through said fastener hole in a respective one of said upper and lower fastener tabs for securing said frame member onto the vehicle body.

2. The frame device as claimed in claim 1, wherein said upper fastener tabs are configured to abut against a top edge of the upper part of the license plate, and said lower fastener tabs are configured to abut against a bottom edge of the lower part of the license plate when the license plate is mounted on said frame member.

3. The frame device as claimed in claim 1, wherein each of said screw fasteners has a head part that is disposed at a front side of the respective one of said upper and lower fastener tabs, and that is for pressing the license plate against a corresponding one of said upper and lower frame edge portions.

4. The frame device as claimed in claim 1, wherein said upper fastener tabs cooperate with said upper frame portion to clamp the upper part of the license plate, and said lower fastener tabs cooperate with said lower frame portion to clamp the lower part of the license plate when the license plate is mounted on said frame member.

5. The frame device as claimed in claim 4, the license plate being formed with a plurality of mounting holes, wherein said fastener hole in each of said upper and lower fastener tabs is disposed to be aligned with a respective one of the mounting holes in the license plate, each of said screw fasteners being extendible through one of the mounting holes in the license plate and said fastener hole in the respective one of said upper and lower fastener tabs for securing said frame member onto the vehicle body.
